(19) United States
(12) Patent Application Publication
(10) Pub. No.: US 2026/0036879 A1
(43) Pub. Date: Feb. 5, 2026

(54) CAMERA STRUCTURE

(71) Applicant: Luxshare Intelligent Manufacture Technology (Changshu) Co., Ltd., Changshu City (CN)

(72) Inventors: Ngoc-Luong NGUYEN, Changshu City (CN); Li-Jhen Chen, Taipei City (TW); Po-Ying Tseng, Taipei City (TW)

(73) Assignee: Luxshare Intelligent Manufacture Technology (Changshu) Co., Ltd., Changshu City (CN)

(21) Appl. No.: 19/284,394

(22) Filed: Jul. 29, 2025

(30) Foreign Application Priority Data
Jul. 30, 2024 (CN) 202411036860.0

(51) Int. Cl. G03B 13/36; G03B 5/04

(52) U.S. Cl. CPC G03B 13/36; G03B 5/04; G03B 2205/0015; G03B 2205/0069

(57) ABSTRACT

A camera structure includes: a moving element is located between a first moving portion and a second moving portion. The moving element includes a body portion and two cone portions, wherein the cone portions are located at two ends of the body portion. The first moving portion has two first supporting portions. The two first supporting portions have two first supporting inclined planes. The second moving portion has two second supporting portions. The two second supporting portions have a second supporting inclined plane. The two first supporting inclined planes are in contact with the tapered surface on one side of the cone portion. The two second supporting inclined planes are in contact with the tapered surface on the other side of the cone portion. The moving element is configured to move along the first supporting inclined plane and second supporting inclined plane.

### CROSS REFERENCE TO RELATED APPLICATION

This application claims the priority benefit of Chinese Patent Application Serial Number 202411036860.0, filed on Jul. 30, 2024, the full disclosure of which is incorporated herein by reference.

### BACKGROUND OF THE INVENTION

### 1. Field of the Invention

The present invention relates to a technical field of photography, more particularly, it relates to a camera structure.

### 2. Description of the Related Art

Imaging devices typically have an anti-shake mechanism. When a user holds the imaging device for capturing images, there can be unstable shaking or vibrations, which affect the quality of the captured images. Optical image stabilization technology compensates for light fluctuations in the image, resulting in high-quality captured images. However, conventional technology uses a ball-type anti-shake design, where the ball rolls within a V-shaped groove. The contact between the ball and the groove is multi-point, and the point-contact method results in excessive stress. Over time, the point-contact areas can lead to severe friction, causing issues such as debris, contamination, and other abnormalities.

### SUMMARY OF THE INVENTION

In some embodiments, a camera structure includes: a moving structure and an imaging lens. The moving structure includes a first moving portion, a second moving portion and a moving element, the moving element is located between the first moving portion and the second moving portion, the moving element includes a body portion and two cone portions, the two cone portions are located at two ends of the body portion, the first moving portion includes two first supporting portions, the two first supporting portions respectively includes a first supporting inclined plane, the two first supporting inclined planes are respectively corresponded to a tapered surface of the two cone portions, the second moving portion includes two second supporting portions, the two second supporting portions respectively includes a second supporting inclined plane, the two second supporting inclined plane are respectively corresponded to the tapered surface of the two cone portions, wherein a slope of the two first supporting inclined planes and a slope of the two second supporting inclined plane are respectively corresponded to a slope of the tapered surface of the two cone portions, the two first supporting inclined planes are in contact with the tapered surface on one side of the cone portion, the two second supporting inclined planes are in contact with the tapered surface on the other side of the cone portion, the moving element is configured to move along the first supporting inclined plane and second supporting inclined plane when the first moving portion and second moving portion are displaced relative to each other; and the imaging lens is displaced via the moving structure.

In one of the embodiments, the first moving portion further includes a first recess, the first recess is located between the two first supporting portions, the first recess is corresponded to the body portion, the second moving portion further includes a second recess, the second recess is located between the two second supporting portions, and the second recess is corresponded to the body portion.

In one of the embodiments, the first recess includes a first bottom surface and two first inclined planes, the two first inclined planes are located on two sides of the first bottom surface, an outer side of the two first inclined planes are respectively extended and connected to an inner side of the first supporting inclined plane of the two first supporting portions, the second recess includes a second bottom surface and two second inclined planes, the two second inclined planes are located on two sides of the second bottom surface, an outer side of the two second inclined planes are respectively extended and connected to an inner side of the second supporting inclined plane of the two second supporting portions.

In one of the embodiments, the first supporting portion includes a first plane, an outer side of the first supporting inclined plane is connected to the first plane, the second supporting portion includes a second plane, an outer side of the second supporting inclined plane is connected to the second plane.

In one of the embodiments, a slope of the first inclined plane relative to a centerline of the moving element is greater than the slope of the first supporting inclined plane relative to the centerline; a slope of the second inclined plane relative to the centerline is greater than the slope of the second supporting inclined plane relative to the centerline; wherein the centerline is a connecting line between two centers of two end faces of the two cone portions.

In one of the embodiments, the tapered surface of the two cone portions have the same slope relative to a centerline of the moving element, the two first supporting inclined planes and the two second supporting inclined planes have the same slope relative to the centerline; wherein the centerline is a connecting line between two centers of two end faces of the two cone portions.

In one of the embodiments, the tapered surface of the two cone portions have different slopes relative to a centerline of the moving element, the two first supporting inclined planes have different slopes relative to the centerline, and the two second supporting inclined planes have different slopes relative to the centerline; wherein the centerline is a connecting line between two centers of two end faces of the two cone portions.

In one of the embodiments, the first supporting inclined plane has a first width on a direction parallel to the tapered surface of the cone portion, the second supporting inclined plane has a second width on a direction parallel to the tapered surface of the cone portion, the tapered surface of the cone portion has a taper width on a direction parallel to the first supporting inclined plane or the second supporting inclined plane; wherein at least one of the first width and the second width is smaller than the taper width.

In one of the embodiments, the camera structure further includes a base assembly and a first moving assembly, the first moving assembly is located in the base assembly, the moving structure includes a first moving structure, the first moving structure is located between an inner wall of the base assembly and an outer wall of the first moving assembly, the base assembly includes the first moving portion, the first moving assembly includes the second moving portion, the first moving structure guides the first moving assembly to move back and forth in a first direction relative to the base assembly.

In one of the embodiments, the base assembly includes a base and a first coil, the first coil is located on the base, the first moving assembly includes a first moving body and a first magnet, the first magnet is located on the first moving body, the first coil is corresponded to the first magnet, a magnetic pole direction of the first magnet is parallel to the first direction.

In one of the embodiments, the base includes a base accommodation trough, a trough sidewall of the base accommodation trough includes a first notch, the first coil is located in the first notch, the first moving body includes a first accommodation trough, the first magnet is located in the first accommodation trough, a position of the first notch is corresponded to a position of the first accommodation trough.

In one of the embodiments, the camera structure further includes a second moving assembly, the moving structure includes a second moving structure, the second moving assembly is located in the first moving assembly, the second moving structure is located between a top of the first moving assembly and a bottom of the second moving assembly, the first moving assembly includes the first moving portion, the second moving assembly includes the second moving portion, the second moving structure guides the second moving assembly to move back and forth in a second direction relative to the first moving assembly, the second direction and the first direction are perpendicular to each other.

In one of the embodiments, the camera structure further includes a lens base assembly, the moving structure includes a third moving structure, the lens base assembly is located on the second moving assembly, the third moving structure is located between a top of the second moving assembly and a bottom of the lens base assembly, the second moving assembly includes the first moving portion, the lens base assembly includes the second moving portion, the third moving structure guides the lens base assembly to move back and forth in a third direction relative to the second moving assembly, the third direction and the second direction are perpendicular to each other.

In one of the embodiments, the base assembly includes a base and a second coil, the second coil is located on the base, the lens base assembly includes a lens base and a second magnet, the second magnet is located on the lens base, the second magnet is corresponded to the second coil, a magnetic pole direction of the second magnet is parallel to the second direction.

In one of the embodiments, the base includes a base accommodation trough, a trough sidewall of the base accommodation trough further includes a second notch, the second coil is located in the second notch, the lens base includes a second accommodation trough, the second magnet is located in the second accommodation trough, a position of the second notch is corresponded to a position of the second accommodation trough.

In one of the embodiments, the base assembly includes a base and a third coil, the third coil is located on the base, the lens base assembly includes a lens base and a third magnet, the third magnet is located on the lens base, the third magnet is corresponded to the third coil, a magnetic pole direction of the third magnet is parallel to the third direction.

In one of the embodiments, the base includes a base accommodation trough, a trough sidewall of the base accommodation trough further includes a third notch, the third coil is located in the third notch, the lens base includes a third accommodation trough, the third magnet is located in the third accommodation trough, a position of the third notch is corresponded to a position of the third accommodation trough.

In one of the embodiments, the camera structure further includes a spring plate, the spring plate is located on the first moving assembly, and the spring plate presses against on the lens base assembly.

In one of the embodiments, the spring plate is arranged along a side of the first moving assembly, and a side of the spring plate extends downward to a fixing part, the first moving assembly includes a fixed trough which is corresponded, the fixing part of the spring plate is correspondingly fixed to be in the fixed trough of the first moving assembly.

### BRIEF DESCRIPTION OF THE DRAWINGS

The accompanying drawings described herein are provided to offer a further understanding of this application and constitute a part of it. The illustrative embodiments and their descriptions are used to explain this application and do not impose undue limitations on it. In the drawings:

FIG. 1 is a perspective view of the camera structure of an embodiment in this invention;

FIG. 2 is a cross-sectional view along line A-A′ of FIG. 1;

FIG. 3 is an enlarged view of area D in FIG. 2;

FIG. 4 is a cross-sectional view along line B-B′ of FIG. 1;

FIG. 5 is a cross-sectional view along line C-C′ of FIG. 4;

FIG. 6 is a partially exploded perspective view of the camera structure in this invention;

FIG. 7 is an enlarged view of area E in FIG. 6;

FIG. 8 is another partially exploded perspective view of the camera structure of an embodiment in the present invention;

FIG. 9 is another partially exploded perspective view of the camera structure of an embodiment in the present invention; and

FIG. 10 is an exploded perspective view of the camera structure of an embodiment in the present invention.

The descriptions are as follows in conjunction with the drawings: 1: camera structure; 11, 11A, 11B, 11C: moving structure; 111, 111A, 111B, 111C: first moving portion; 1111: first supporting portion; 1112: first supporting inclined plane; 1113: first recess; 1114: first bottom surface; 1115: first inclined plane; 1116: first plane; 112, 112A, 112B, 112C: second moving portion; 1121: second supporting portion; 1122: second supporting inclined plane; 1123: second recess; 1124: second bottom surface; 1125: second inclined plane; 1126: second plane; 113, 113A, 113B, 113C: moving element; 1131: body portion; 1132: cone portion; 12: imaging lens; 13: base assembly; 131: base; 1310: base accommodation trough; 1311: first notch; 1312: second notch; 1313: third notch; 132: first coil; 133: second coil; 134: third coil; 14: first moving assembly; 140: accommodation concave slot; 141: first moving body; 1411: first accommodation trough; 142: first magnet; 143: fixed trough; 15: second moving assembly; 16: lens base assembly; 161: lens base; 1611: second accommodation trough; 1612: third accommodation trough; 162: second magnet; 163: third magnet; 17: circuit board; 18: spring plate; 181: fixing part; W1: first width; W2: second width; W3: taper width; Z: first direction; Y: second direction; X: third direction.

### DETAILED DESCRIPTION OF THE PREFERRED EMBODIMENT

The following will disclose multiple embodiments of this invention using the drawings. For the sake of clear explanation, many implementation details will be described together in the following narrative. However, it should be understood that these implementation details should not be used to limit this invention. In other words, in some embodiments of this invention, these implementation details are not necessary. Moreover, to simplify the drawings, some conventional structures and components are depicted in a simple schematic manner. In the following embodiments, the same reference numbers are used to represent the same or similar components.

In some embodiments of the present invention, a camera structure uses a moving element to cooperate with the rolling of the first moving portion and the second moving portion, to solve the friction problem of excessive stress caused by the point contact of conventional balls.

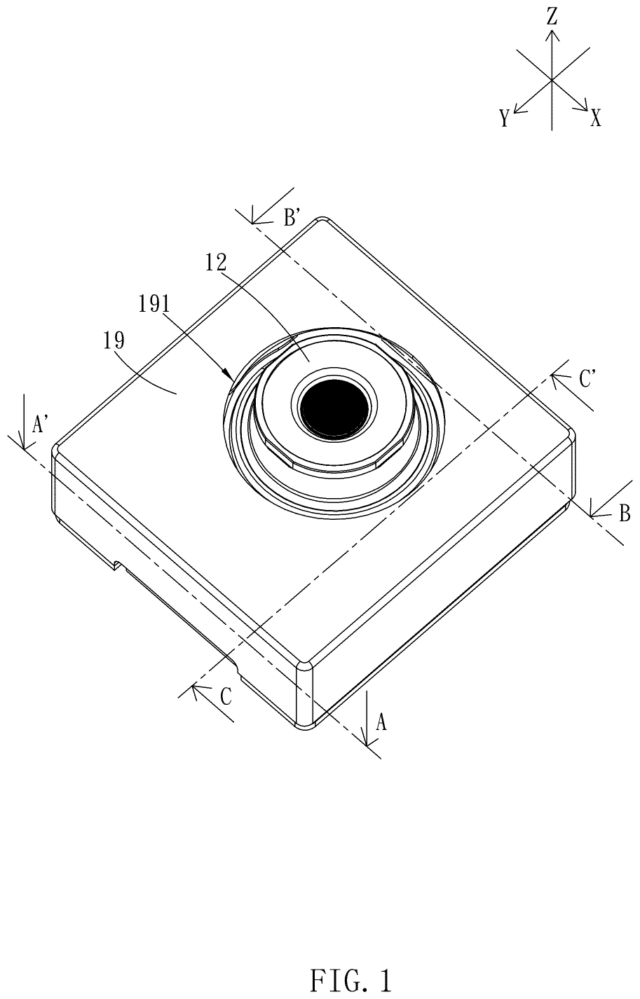

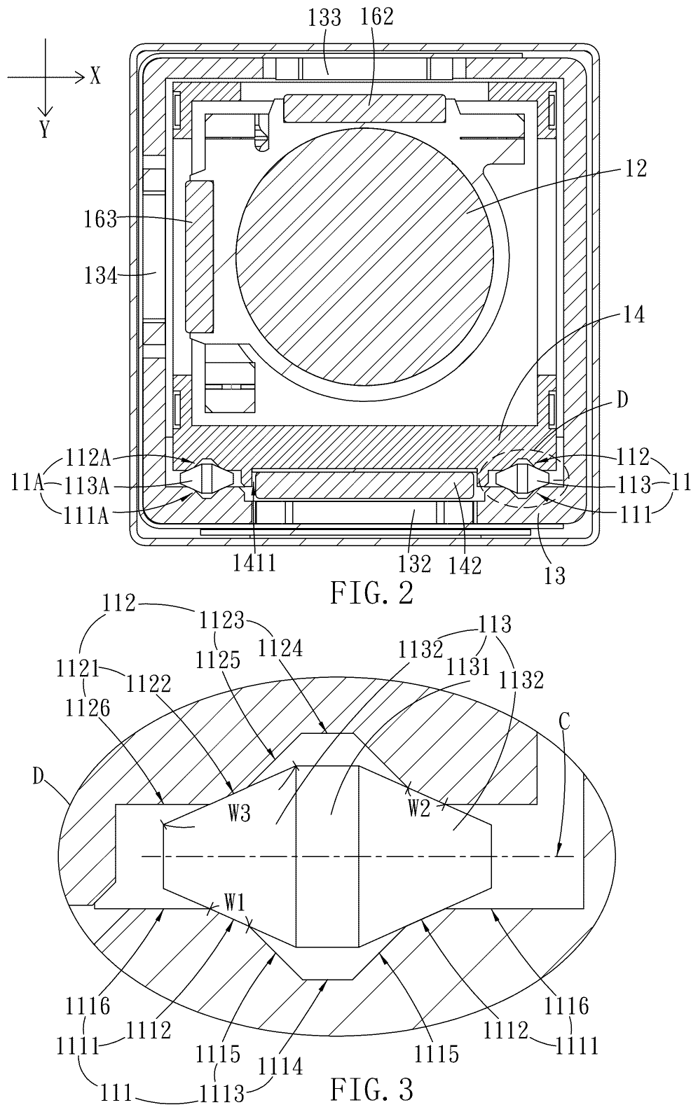

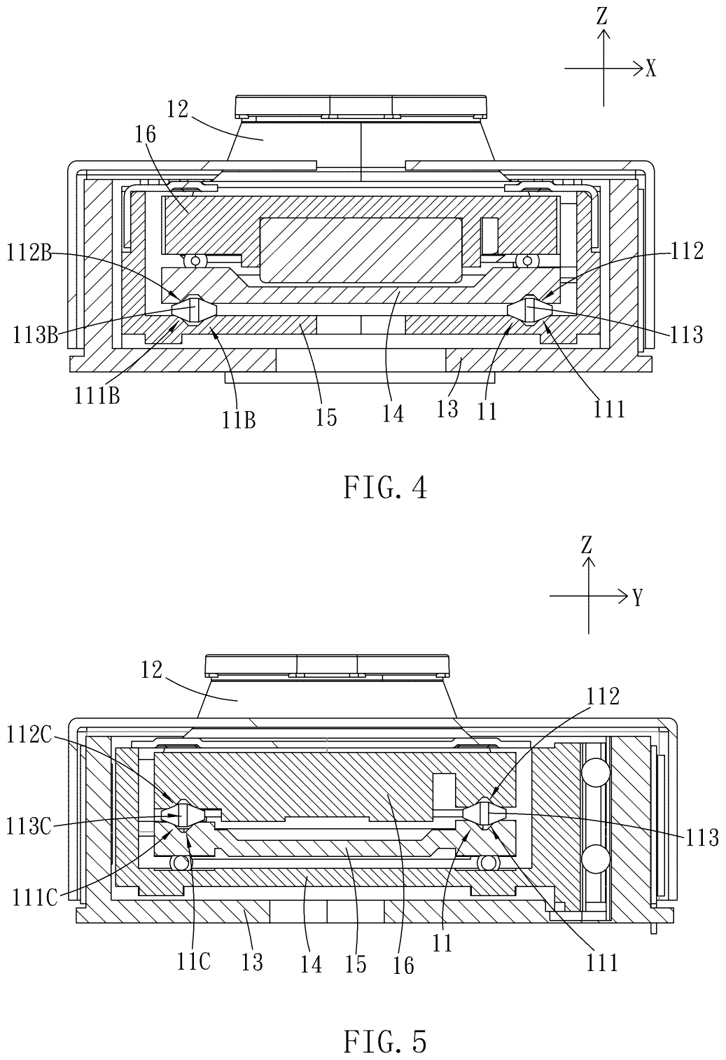

Please refer to FIG. 1 to FIG. 5, FIG. 1 is a perspective view of the camera structure in the present invention, FIG. 2 is a cross-sectional view along line A-A′ of FIG. 1, FIG. 3 is an enlarged view of area D in FIG. 2, FIG. 4 is a cross-sectional view along line B-B′ of FIG. 1, and FIG. 5 is a cross-sectional view along line C-C′ of FIG. 1. As shown in the figures, in this embodiment, a camera structure 1 is provided, which includes a moving structure 11 and an imaging lens 12. The moving structure 11 includes a first moving portion 111, a second moving portion 112, and a moving element 113; the moving element 113 is located between the first moving portion 111 and the second moving portion 112; the moving element 113 includes a body portion 1131 and two cone portions 1132, the two cone portions 1132 are located at two ends of the body portion 1131; the first moving portion 111 includes two first supporting portions 1111, the two first supporting portions 1111 respectively has a first supporting inclined plane 1112, the two first supporting inclined planes 1112 are respectively correspond to the tapered surfaces of the two cone portions 1132. The second moving portion 112 includes two second supporting portions 1121, the two second supporting portions 1121 respectively has a second supporting inclined plane 1122, The two second supporting inclined planes 1122 are respectively correspond to the tapered surfaces of the two cone portions 1132; the slope of the first supporting inclined planes 1112 and the slope of the second supporting inclined planes 1122 are respectively corresponded to the slope of the tapered surfaces of the two cone portions 1132; the two first supporting inclined planes 1112 are in contact with the tapered surfaces on one side of the cone portion 1132, while the two second supporting inclined planes 1122 are in contact with the tapered surfaces on the other side of the cone portion 1132; the moving element 113 is configured to move along the two first supporting inclined planes 1112 and the two second supporting inclined planes 1122 when the first moving portion 111 and the second moving portion 112 are displaced relative to each other. The imaging lens 12 is displaced via the moving structure 11. The moving structure 11 in this embodiment can provide the imaging lens 12 with Auto Focus (AF) and/or Optical Image Stabilization (OIS) functionality.

Please also refer to FIG. 3, in this embodiment, two ends of the outer side of the moving element 113 are respectively two cone portions 1132, and the two ends of the two cone portions 1132 are round end faces; the outer diameter of the two cone portions 1132 of the moving element 113 gradually increases from the round end face of the outer side to the body portion 1131 of the inner side; the inner side end faces of the two cone portions 1132 are connected to the body portion 1131, and the outer diameter of the two cone portions 1132 adjacent to the body portion 1131 is equal to the outer diameter of the body portion 1131. Additionally, the centerline C of the moving element 113 is the connecting line between the center points of the outer side ends of the two cone portions 1132, and the two side edges of the moving element 113 are symmetrical relative to the centerline C. The first moving portion 111 and the second moving portion 112 are corresponded to and abut the side edges of the moving element 113 on two sides, thus making the first moving portion 111 and the second moving portion 112 also symmetrical relative to the centerline C.

In this embodiment, the cone portion 1132 is shaped as a trapezoidal shape in the cross-section along the centerline C, which means that the cone portion 1132 has a round end face, and the centerline C is the connecting line between the centers of the round end faces of the two cone portions 1132. In some embodiments, the cone portion 1132 is shaped as a triangular shape in the cross-section along the centerline C, which means that the cone portion 1132 has a pointed tip, and the centerline C is the connecting line between the tips of the two cone portions 1132. The shape of the cone portion 1132 can be selected based on the user's requirements. In some embodiments, the tapered surfaces of the two cone portions 1132 have the same slope relative to the centerline C. Accordingly, the two first supporting inclined planes 1112 and the two second supporting inclined planes 1122 have the same slope relative to the centerline C, which means that there is a symmetrical structure of the same size between the two cone portions 1132. In some embodiments, the tapered surfaces of the two cone portions 1132 have different slopes relative to the centerline C. Accordingly, the two first supporting inclined planes 1112 are respectively corresponded to the tapered surfaces of the two cone portions 1132 and have different slopes relative to the centerline C, and the two second supporting inclined planes 1122 are respectively corresponded to the tapered surfaces of the two cone portions 1132 and have different slopes relative to the centerline C, which means that there is an asymmetrical structure with different sizes between the two cone portions 1132. In some embodiments, the moving element 113 rolls along the two first supporting inclined planes 1112 and the two second supporting inclined planes 1122.

Furthermore, the first moving portion 111 includes a first recess 1113, the first recess 1113 is located between the two first supporting portions 1111, and the first recess 1113 is corresponded to the body portion 1131 in the middle of the moving element 113. The second moving portion 112 also includes a second recess 1123, the second recess 1123 is located between the two second supporting portions 1121, and the second recess 1123 is also corresponded to the body portion 1131 in the middle of the moving element 113. The first recess 1113 includes a first bottom surface 1114 and two first inclined planes 1115, the two first inclined planes 1115 are located on two sides of the first bottom surface 1114, and the outer sides of the two first inclined planes 1115 respectively extend and connect to the inner sides of the first supporting inclined planes 1112 of the two first supporting portions 1111. The first supporting portion 1111 includes a first plane 1116, and the outer side of the first supporting inclined plane 1112 is connected to the first plane 1116. Similarly, the second recess 1123 includes a second bottom surface 1124 and two second inclined planes 1125, the two second inclined planes 1125 are located on two sides of the second bottom surface 1124, and the outer sides of the two second inclined planes 1125 respectively extend and connect to the inner sides of the second supporting inclined planes 1122 of the two second supporting portions 1121. The second supporting portion 1121 includes a second plane 1126, and the outer side of the second supporting inclined plane 1122 is connected to the second plane 1126. In some embodiments, the slope of the first inclined plane 1115 relative to the centerline C is greater than the slope of the first supporting inclined plane 1112 relative to the centerline C. In some embodiments, the slope of the second inclined plane 1125 relative to the centerline C is greater than the slope of the second supporting inclined plane 1122 relative to the centerline C.

In this embodiment, two sides of the moving element 113 are secured by the first moving portion 111 and the second moving portion 112. The two first supporting inclined planes 1112 of the first moving portion 111 are respectively located at two ends of one side of the moving element 113, and the two second supporting inclined planes 1122 of the second moving portion 112 are respectively located at two ends of the other side of the moving element 113. In other words, the tapered surfaces on two sides of the two cone portions 1132 of the moving element 113 are in contact with the first supporting inclined planes 1112 and the second supporting inclined planes 1122. The two first supporting inclined planes 1112 and the two second supporting inclined planes 1122 are inclined towards the inner side, allowing the side (which is the tapered surface) of the two cone portions 1132 of the moving element 113 to fit snugly against the first supporting inclined planes 1112 and the second supporting inclined planes 1122 on two sides, which ensures that the moving element 113 is securely positioned between the first moving portion 111 and the second moving portion 112, and the rolling stress of the moving element 113 is concentrated towards the inner side, reducing the likelihood of sliding friction. Additionally, the first supporting inclined planes 1112 make line contact with the cone portions 1132 of the moving element 113, which helps prevent the problem of excessive stress from point contact that could cause damage due to friction between the moving element 113 and the first moving portion 111 or the second moving portion 112.

As shown in FIG. 3, the first supporting inclined plane 1112 has a first width W1 in the direction parallel to the tapered surface of the cone portion 1132, the second supporting inclined plane 1122 has a second width W2 in the direction parallel to the tapered surface of the cone portion 1132, and the tapered surface of the cone portion 1132 has a taper width W3 in the direction parallel to the first supporting inclined plane 1112 or the second supporting inclined plane 1122. In some embodiments, the first width W1 is smaller than the taper width W3. In some embodiments, the second width W2 is smaller than the taper width W3. In some embodiments, both the first width W1 and the second width W2 are smaller than the taper width W3. In some embodiments, the taper widths W3 of the two cone portions 1132 are the same. In some embodiments, the taper widths W3 of the two cone portions 1132 are different.

Furthermore, the body portion 1131 of the moving element 113 is corresponded to the first recess 1113 of the first moving portion 111 and the second recess 1123 of the second moving portion 112. In other words, the body portion 1131 of the moving element 113 is not in contact with the first moving portion 111 or the second moving portion 112, thus, the body portion 1131 of the moving element 113 is suspended and not subjected to any frictional constraints.

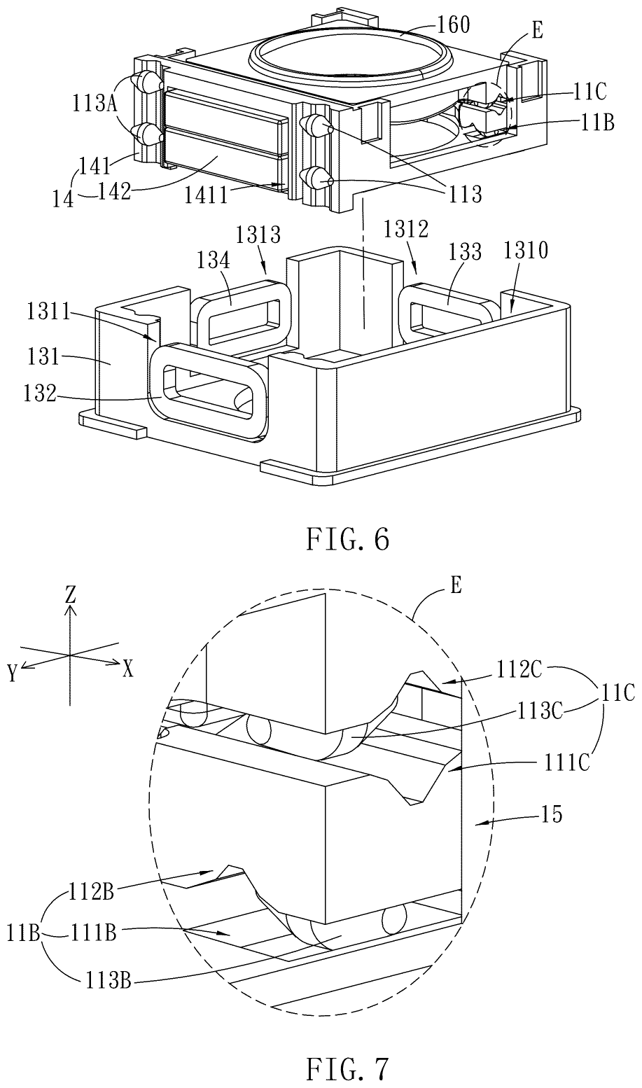

Please also refer to FIG. 6, which is an exploded perspective view of the camera structure of the present invention. As shown in the figure, in this embodiment, the camera structure 1 further includes a base assembly 13 and a first moving assembly 14, and the first moving assembly 14 is located within the base assembly 13. The moving structure 11 includes a first moving structure 11A, and the first moving structure 11A is located between the inner wall of the base assembly 13 and the outer wall of the first moving assembly 14. The base assembly 13 includes a first moving portion 111A, the first moving assembly 14 includes a second moving portion 112A, and a moving element 113A is located between the first moving portion 111A and the second moving portion 112A. In this embodiment, there are multiple moving elements 113, and these multiple moving elements 113 are located on two sides of the camera structure 1, the multiple moving elements 113 on two sides have one end with a cone portion 1132 arranged corresponding to each other. The multiple moving elements 113 are arranged along the first direction Z between the base assembly 13 and the first moving assembly 14. The first moving structure 11A guides the first moving assembly 14 to move back and forth relative to the base assembly 13 in the first direction Z (which is the vertical direction).

Additionally, the base assembly 13 includes a base 131 and a first coil 132, and the first coil 132 is located on the base 131. The first moving assembly 14 includes a first moving body 141 and a first magnet 142, and the first magnet 142 is located on the first moving body 141, the first coil 132 is corresponded to the first magnet 142, and the magnetic pole direction of the first magnet 142 is parallel to the first direction Z. The base 131 includes a base accommodation trough 1310, the sidewall of the base accommodation trough 1310 includes a first notch 1311, and the first coil 132 is located in the first notch 1311. The first moving body 141 includes a first accommodation trough 1411, the first magnet 142 is located in the first accommodation trough 1411, and the position of the first notch 1311 is corresponded to the position of the first accommodation trough 1411.

Continuing from the above, the magnetic pole direction of the first magnet 142 is arranged parallel to the first direction Z, which means that the S and N poles of the magnet are aligned in the vertical direction. When an electric current passes through the first coil 132, it generates a corresponding magnetic field, the magnetic field of the first coil 132 interacts with the magnetic poles of the first magnet 142. This interaction produces a repulsive or attractive force between the first moving assembly 14 and the base 131, causing the first moving assembly 14 to move relative to the base 131 against multiple moving elements 113A, to furthermore drive the first moving assembly 14 to move back and forth relative to the base 131 in the first direction Z. Consequently, the imaging lens 12 is displaced via the first moving structure 11A, achieving the Auto Focus function of the camera structure 1.

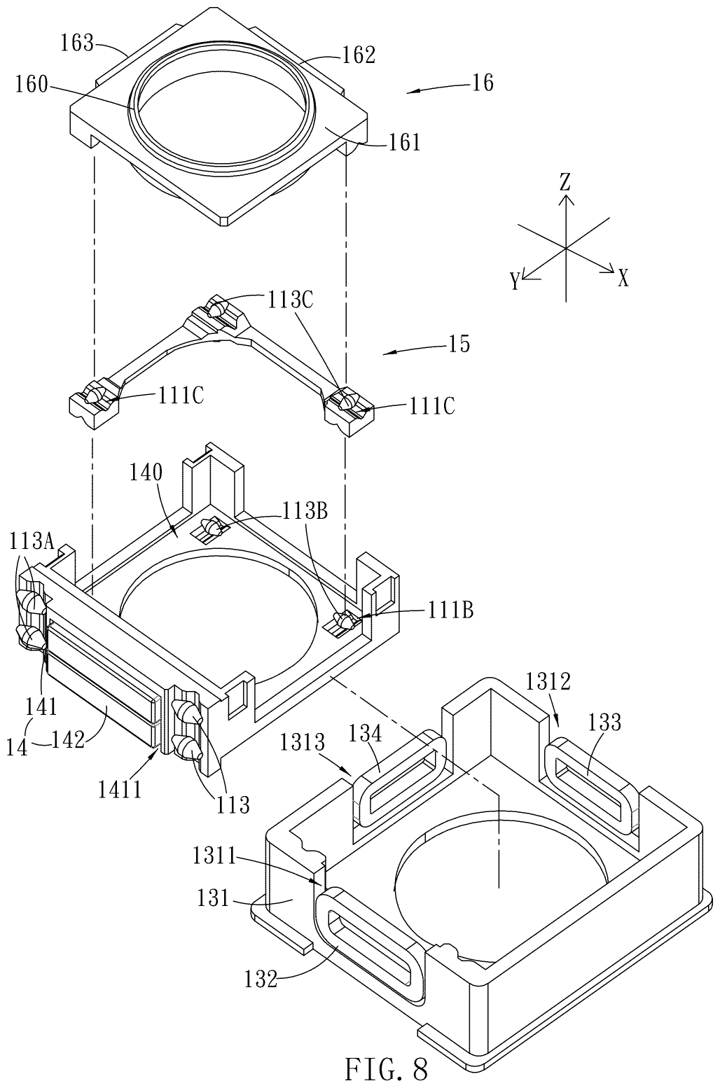

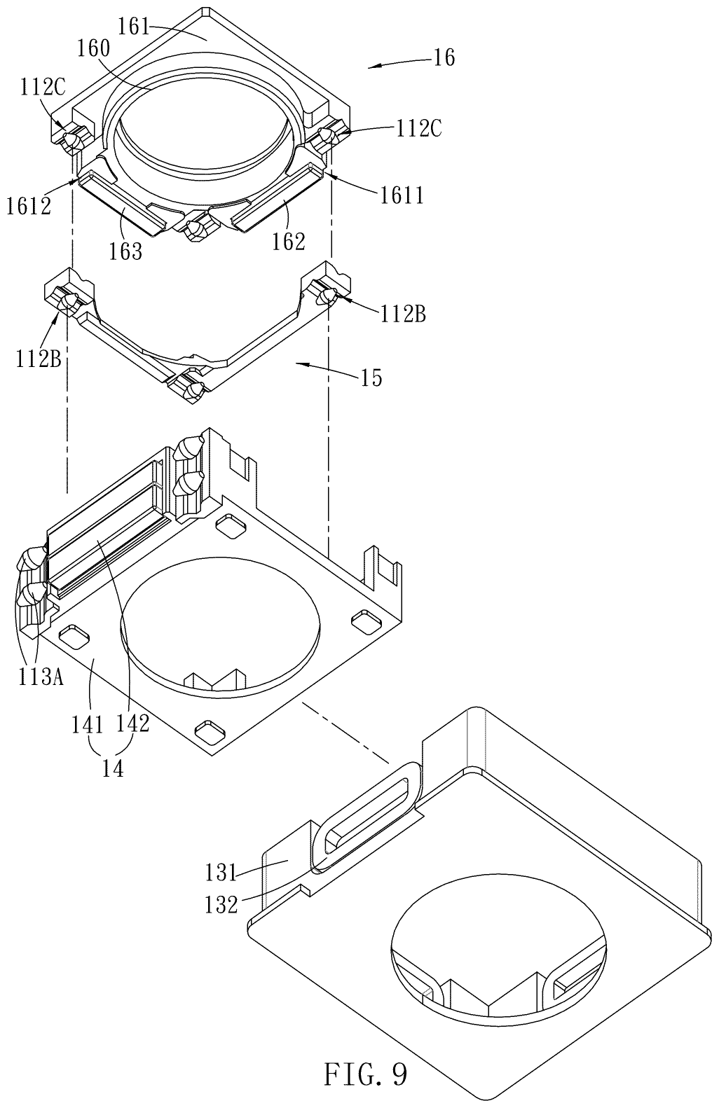

Please refer to FIG. 7 to FIG. 9. FIG. 7 is an enlarged view of the E area in FIG. 6, FIG. 8 is a partially exploded perspective view of the camera structure, and FIG. 9 is another partially exploded perspective view of the camera structure. As shown is the figures, the structure further includes a second moving assembly 15, the moving structure 11 includes a second moving structure 11B, the first moving assembly 14 includes an accommodation concave slot 140, the second moving assembly 15 is located in the accommodation concave slot 140 of the first moving assembly 14. The second moving structure 11B is located between the bottom of the accommodation concave slot 140 of the first moving assembly 14 and the bottom of the second moving assembly 15. The first moving assembly 14 includes a first moving portion 111B, the second moving assembly 15 includes a second moving portion 112B. The second moving structure 11B guides the second moving assembly 15 to move back and forth relative to the first moving assembly 14 in the second direction Y (which is the horizontal direction), and the second direction Y is perpendicular to the first direction Z.

Continuing from the above, there are three moving elements 113B in this embodiment. The bottom of the slot of the accommodation concave slot 140 of the first moving assembly 14 includes three first moving portions 111B. The second moving assembly 15 is an L-shaped structure, the second moving portions 112B are located at two ends and at the L-corner of the second moving assembly 15. The three moving elements 113B form a movable support plane, and the three moving elements 113B are correspondingly assembled between the second moving portions 112B of the second moving assembly 15 and the first moving portions 111B of the first moving assembly 14.

In this embodiment, the camera structure 1 further includes a lens base assembly 16, the moving structure 11 includes a third moving structure 11C, and the lens base assembly 16 is located above the second moving assembly 15. The third moving structure 11C is located between the top of the second moving assembly 15 and the bottom of the lens base assembly 16. The second moving assembly 15 includes a first moving portion 111C, and the lens base assembly 16 includes a second moving portion 112C. The third moving structure 11C guides the lens base assembly 16 to move back and forth relative to the second moving assembly 15 in the third direction X (which is the horizontal direction). The third direction X is perpendicular to the second direction Y. Additionally, the third direction X is also perpendicular to the first direction Z.

Continuing from the above, there are three moving elements 113C in this embodiment, the second moving assembly 15 is an L-shaped structure, and the positions of the three moving elements 113C are corresponded to the positions of the three moving elements 113B. The three moving elements 113C are similarly located at the two ends and the L-corner of the second moving assembly 15, and the three moving elements 113C form a movable support plane. The lens base assembly 16 is the lens frame for assembling the imaging lens 12, and the second moving portion 112C is located at the three corner locations on the bottom of the lens base assembly 16. The three moving elements 113C are correspondingly assembled between the second moving assembly 15 and the lens base assembly 16.

In this embodiment, the second moving structure 11B and the third moving structure 11C are used for providing horizontal displacement. The multiple moving elements 113B of the second moving structure 11B have one end with the cone portion 1132 facing the inner side. Similarly, the multiple moving elements 113C of the third moving structure 11C also have one end with the cone portion 1132 facing the inner side. Additionally, the imaging lens 12 of this embodiment is located on the lens base assembly 16, wherein the lens base assembly 16 includes an assembly hole 160. The imaging lens 12 can be fitted into the assembly hole 160, allowing the imaging lens 12 to be driven to move via the base assembly 13, the first moving assembly 14, the second moving assembly 15, and the lens base assembly 16.

In this embodiment, the base assembly 13 includes a base 131 and a second coil 133, the second coil 133 is located on the base 131, wherein the trough sidewall of the base accommodation trough 1310 of the base 131 further includes a second notch 1312, and the first notch 1311 and the second notch 1312 are located on different trough sidewalls of the base accommodation trough 1310. The second coil 133 is located in the second notch 1312. The lens base assembly 16 includes a lens base 161 and a second magnet 162, the second magnet 162 is located on the lens base 161, wherein the lens base 161 includes a second accommodation trough 1611, and the second magnet 162 is located in the second accommodation trough 1611. The position of the second notch 1312 is corresponded to the position of the second accommodation trough 1611, thus, the second magnet 162 is corresponded to the second coil 133. The magnetic pole direction of the second magnet 162 is arranged to be parallel to the second direction Y, which means that the S and N poles of the magnet are oriented horizontally. When the current flows through the second coil 133, the magnetic pole of the second coil 133 interacts with the magnetic pole of the second magnet 162, allowing the second coil 133 to generate a repulsive or attractive force relative to the second magnet 162. Thus, the lens base assembly 16 is displaced in the second direction Y via the second moving structure 11B located between the second moving assembly 15 and the first moving assembly 14. Furthermore, this setup drives the lens base assembly 16 and the second moving assembly 15 to perform reciprocating displacement in the second direction Y relative to the first moving assembly 14. Because the third moving structure 11C restricts and guides the lens base assembly 16 to reciprocate only relative to the second moving assembly 15 in the third direction X (as shown in FIG. 6 and FIG. 7), the lens base assembly 16 and the second moving assembly 15 do not move relative to each other in the second direction Y when the second coil 133 and the second magnet 162 interact to drive the lens base assembly 16 and the second moving assembly 15 to reciprocate relative to the first moving assembly 14 in the second direction Y.

Furthermore, the base assembly 13 includes the base 131 and a third coil 134, the third coil 134 is located on the base 131, wherein the trough sidewall of the base accommodation trough 1310 of the base 131 also includes a third notch 1313, and the first notch 1311, the second notch 1312, and third notch 1313 are respectively located on different trough sidewalls of the base accommodation trough 1310. The third coil 134 is located in the third notch 1313. The lens base assembly 16 includes a lens base 161 and a third magnet 163, the third magnet 163 is located on the lens base 161, wherein the lens base 161 includes a third accommodation trough 1612, the third magnet 163 is located in the third accommodation trough 1612, and the position of the third notch 1313 is corresponded to the position of the third accommodation trough 1612. Thus, the third coil 134 is corresponded to the third magnet 163, and the magnetic pole direction of the third magnet 163 is parallel to the third direction X. When the current flows through the third coil 134, the magnetic pole of the third coil 134 interacts with the magnetic pole of the third magnet 163, allowing the third coil 134 to create a repulsive or attractive force relative to the third magnet 163. Thus, the lens base assembly 16 is displaced along the third direction X via the third moving structure 11C, moreover, this setup enables the lens base assembly 16 to perform a reciprocating displacement in the third direction X relative to the second moving assembly 15. Because the second moving structure 11B restricts and guides the second moving assembly 15 to reciprocate only relative to the first moving assembly 14 in the second direction Y (as shown in FIG. 6 and FIG. 7), the second moving assembly 15 and the first moving assembly 14 do not move relative to each other in the third direction X when the third coil 134 and the third magnet 163 interact to drive the lens base assembly 16 to reciprocate relative to the second moving assembly 15 in the third direction X. Thus, the imaging lens 12 can be displaced via the second moving structure 11B and the third moving structure 11C, achieving the Optical image stabilization function of the camera structure 1.

In this embodiment, the moving structure 11 includes a first moving structure 11A, a second moving structure 11B, and a third moving structure 11C. The first moving structure 11A, second moving structure 11B, and third moving structure 11C are all of the same structure (as shown in FIG. 3). The first moving structure 11A is used for moving back and forth along the first direction Z, the second moving structure 11B is used for moving back and forth along the second direction Y, and the third moving structure 11C is used for moving back and forth along the third direction X. The purpose of the moving structure 11 is to provide adjustment of the imaging lens 12 in three-axis directions.

Please refer again to FIG. 6, the camera structure 1 further includes a circuit board 17, the circuit board 17 is located on a side of the base assembly 13, the circuit board 17 is located adjacent to the first coil 132, the second coil 133, and the third coil 134, and the circuit board 17 is electrically connected to the first coil 132, the second coil 133 and the third coil 134. Moreover, the camera structure 1 further includes a spring plate 18, and the spring plate 18 is located on the first moving assembly 14 and presses against on the lens base assembly 16. The spring plate 18 is located along three sides of the first moving assembly 14. A fixing part 181 is extended downward from an edge of the spring plate 18. In some embodiments, there are three fixing parts 181 respectively extended from three edges of the spring plate 18. The first moving assembly 14 includes the corresponding fixed trough 143, the fixing parts 181 of the spring plate 18 are correspondingly fixed into the fixed trough 143 of the first moving assembly 14. The spring plate 18 is used for constraining movement range of the lens base assembly 16 to correspond to the first moving assembly 14 in at least one of the third direction X and the second direction Y. Additionally, the spring plate 18 is also used for limiting the movement range of the lens base assembly 16 and the imaging lens 12 along the first direction Z (i.e., the focus adjustment range), ensuring that the lens base assembly 16 remains assembled within the first moving assembly 14.

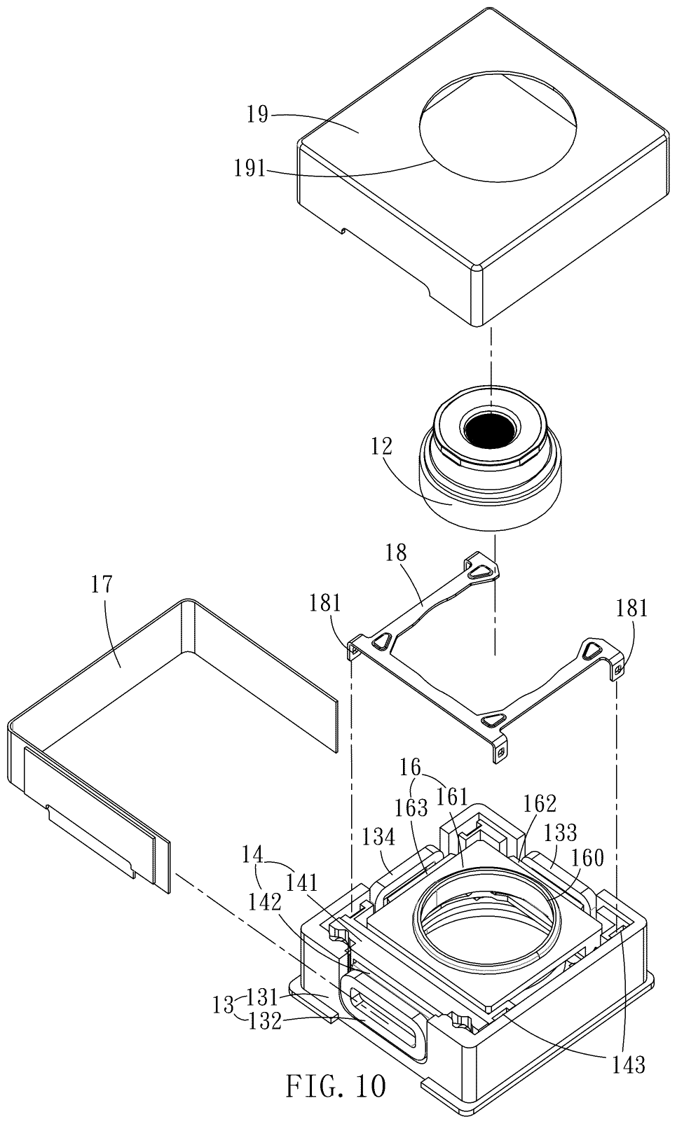

Furthermore, as shown in FIG. 10, the camera structure 1 further includes a protective cover 19, the protective cover 19 includes an aperture 191, the protective cover 19 covers the base assembly 13, allowing the first moving assembly 14, the second moving assembly 15, the lens base assembly 16, the circuit board 17, and spring plate 18 to be covered in the base assembly 13, and the imaging lens 12 of the lens base assembly 16 extends through the aperture 191 of the protective cover 19.

In summary, some embodiments of the present invention provides a camera structure that includes a moving element, a first moving portion, and a second moving portion. The moving element includes a body portion and two cone portions, the two cone portions are located at two ends of the body portion. The first supporting inclined planes of the two first supporting portions of the first moving portion are in contact with one side of the two cone portions, and the second supporting inclined planes of the two second supporting portion of the second moving portion are in contact with the other side of the two cone portions. Thus, the first moving portion and the second moving portion are in line contact relative to the moving element, to enhance the rolling stability of the moving element. This method of contact of the moving element also prevents stress concentration, which could otherwise cause friction damage to the contact surfaces.

It should also be noted that the terms “comprises,” “includes,” or any other variations thereof are intended to cover non-exclusive inclusion, so that a process, method, article, or device that includes a list of elements is not limited to those elements but may also include other elements not explicitly listed or inherent to such a process, method, article, or device. Without further limitation, an element defined by the phrase “comprising one . . . ” does not exclude the presence of additional identical elements in the process, method, article, or device that includes the element.

The above description illustrates and describes several embodiments of this invention, but as previously mentioned, it should be understood that this invention is not limited to the forms disclosed herein and should not be construed as excluding other embodiments. It may be applied in various other combinations, modifications, and environments and may be altered within the scope of the inventive concept, as indicated by the teachings herein or through the invention of techniques or knowledge in the relevant field. Modifications and variations made by those skilled in the art, without departing from the spirit and scope of this invention, should be within the scope of the protection afforded by the appended claims.

What is claimed is:

1. A camera structure, comprising:
a moving structure, comprising a first moving portion, a second moving portion and a moving element, wherein the moving element is located between the first moving portion and the second moving portion, the moving element comprises a body portion and two cone portions, the two cone portions are located at two ends of the body portion, the first moving portion comprises two first supporting portions, each of the two first supporting portions comprises a first supporting inclined plane, the two first supporting inclined planes are respectively corresponded to a tapered surface of the two cone portions, the second moving portion comprises two second supporting portions, each of the two second supporting portions comprises a second supporting inclined plane, the two second supporting inclined plane are respectively corresponded to the tapered surface of the two cone portions, wherein a slope of the two first supporting inclined planes and a slope of the two second supporting inclined planes are respectively corresponded to a slope of the tapered surface of the two cone portions, the two first supporting inclined planes are in contact with the tapered surface on one side of the cone portion, the two second supporting inclined planes are in contact with the tapered surface on the other side of the cone portion, the moving element is configured to move along the first supporting inclined plane and the second supporting inclined plane when the first moving portion and the second moving portion are displaced relative to each other; and
an imaging lens, configured to be displaced via the moving structure.

2. The camera structure as claimed in claim 1, wherein the first moving portion further comprises a first recess, the first recess is located between the two first supporting portions, the first recess is corresponded to the body portion, the second moving portion further comprises a second recess, the second recess is located between the two second supporting portions, and the second recess is corresponded to the body portion.

3. The camera structure as claimed in claim 2, wherein the first recess comprises a first bottom surface and two first inclined planes, the two first inclined planes are located on two sides of the first bottom surface, an outer side of the two first inclined planes are respectively extended and connected to an inner side of the first supporting inclined plane of the two first supporting portions, the second recess comprises a second bottom surface and two second inclined planes, the two second inclined planes are located on two sides of the second bottom surface, an outer side of the two second inclined planes are respectively extended and connected to an inner side of the second supporting inclined plane of the two second supporting portions.

4. The camera structure as claimed in claim 3, wherein the first supporting portion comprises a first plane, an outer side of the first supporting inclined plane is connected to the first plane, the second supporting portion comprises a second plane, an outer side of the second supporting inclined plane is connected to the second plane.

5. The camera structure as claimed in claim 3, wherein a slope of the first inclined plane relative to a centerline of the moving element is greater than the slope of the first supporting inclined plane relative to the centerline; a slope of the second inclined plane relative to the centerline is greater than the slope of the second supporting inclined plane relative to the centerline; wherein the centerline is a connecting line between two centers of two end faces of the two cone portions.

6. The camera structure as claimed in claim 1, wherein the tapered surface of the two cone portions have the same slope relative to a centerline of the moving element, the two first supporting inclined planes and the two second supporting inclined planes have the same slope relative to the centerline; wherein the centerline is a connecting line between two centers of two end faces of the two cone portions.

7. The camera structure as claimed in claim 1, wherein the tapered surface of the two cone portions have different slopes relative to a centerline of the moving element, the two first supporting inclined planes have different slopes relative to the centerline, and the two second supporting inclined planes have different slopes relative to the centerline; wherein the centerline is a connecting line between two centers of two end faces of the two cone portions.

8. The camera structure as claimed in claim 1, wherein the first supporting inclined plane has a first width on a direction parallel to the tapered surface of the cone portion, the second supporting inclined plane has a second width on a direction parallel to the tapered surface of the cone portion, the tapered surface of the cone portion has a taper width on a direction parallel to the first supporting inclined plane or the second supporting inclined plane; wherein at least one of the first width and the second width is smaller than the taper width.

9. The camera structure as claimed in claim 1, further comprising a base assembly and a first moving assembly, wherein the first moving assembly is located in the base assembly, the moving structure comprises a first moving structure, the first moving structure is located between an inner wall of the base assembly and an outer wall of the first moving assembly, the base assembly comprises the first moving portion, the first moving assembly comprises the second moving portion, the first moving structure guides the first moving assembly to move back and forth in a first direction relative to the base assembly.

10. The camera structure as claimed in claim 9, wherein the base assembly comprises a base and a first coil, the first coil is located on the base, the first moving assembly comprises a first moving body and a first magnet, the first magnet is located on the first moving body, the first coil is corresponded to the first magnet, a magnetic pole direction of the first magnet is parallel to the first direction.

11. The camera structure as claimed in claim 10, wherein the base comprises a base accommodation trough, a trough sidewall of the base accommodation trough comprises a first notch, the first coil is located in the first notch, the first moving body comprises a first accommodation trough, the first magnet is located in the first accommodation trough, a position of the first notch is corresponded to a position of the first accommodation trough.

12. The camera structure as claimed in claim 9, further comprising a second moving assembly, wherein the moving structure comprises a second moving structure, the first moving assembly comprises an accommodation concave slot, the second moving assembly is located in the accommodation concave slot of the first moving assembly, the second moving structure is located between the accommodation concave slot of the first moving assembly and a bottom of the second moving assembly, the first moving assembly comprises the first moving portion, the second moving assembly comprises the second moving portion, the second moving structure guides the second moving assembly to move back and forth in a second direction relative to the first moving assembly, the second direction and the first direction are perpendicular to each other.

13. The camera structure as claimed in claim 12, further comprising a lens base assembly, wherein the moving structure comprises a third moving structure, the lens base assembly is located on the second moving assembly, the third moving structure is located between a top of the second moving assembly and a bottom of the lens base assembly, the second moving assembly comprises the first moving portion, the lens base assembly comprises the second moving portion, the third moving structure guides the lens base assembly to move back and forth in a third direction relative to the second moving assembly, the third direction and the second direction are perpendicular to each other.

14. The camera structure as claimed in claim 13, wherein the base assembly comprises a base and a second coil, the second coil is located on the base, the lens base assembly comprises a lens base and a second magnet, the second magnet is located on the lens base, the second magnet is corresponded to the second coil, a magnetic pole direction of the second magnet is parallel to the second direction.

15. The camera structure as claimed in claim 14, wherein the base comprises a base accommodation trough, a trough sidewall of the base accommodation trough further comprises a second notch, the second coil is located in the second notch, the lens base comprises a second accommodation trough, the second magnet is located in the second accommodation trough, a position of the second notch is corresponded to a position of the second accommodation trough.

16. The camera structure as claimed in claim 9, wherein the base assembly comprises a base and a third coil, the third coil is located on the base, the lens base assembly comprises a lens base and a third magnet, the third magnet is located on the lens base, the third magnet is corresponded to the third coil, a magnetic pole direction of the third magnet is parallel to the third direction.

17. The camera structure as claimed in claim 16, wherein the base comprises a base accommodation trough, a trough sidewall of the base accommodation trough further comprises a third notch, the third coil is located in the third notch, the lens base comprises a third accommodation trough, the third magnet is located in the third accommodation trough, a position of the third notch is corresponded to a position of the third accommodation trough.

18. The camera structure as claimed in claim 13, further comprising a spring plate, the spring plate is located on the first moving assembly, and the spring plate presses against on the lens base assembly.

19. The camera structure as claimed in claim 18, wherein the spring plate is arranged along a side of the first moving assembly, a fixing part is extended downward from an edge of the spring plate, the first moving assembly comprises a fixed trough correspondingly, and the fixing part of the spring plate is correspondingly fixed in the fixed trough of the first moving assembly.
